(19) United States
(12) Patent Application Publication
(10) Pub. No.: US 2015/0220829 A1
(43) Pub. Date: Aug. 6, 2015

(54) EQUIVALENT DELAY BY SHAPING POSTSYNAPTIC POTENTIALS

(71) Applicant: QUALCOMM INCORPORATED, San Diego, CA (US)

(72) Inventors: Jason Frank HUNZINGER, Escondido, CA (US); Jeffrey Alexander LEVIN, San Diego, CA (US)

(73) Assignee: QUALCOMM INCORPORATED, San Diego, CA (US)

(21) Appl. No.: 14/172,742

(22) Filed: Feb. 4, 2014

(51) Int. Cl. G06N 3/02

(52) U.S. Cl. CPC G06N 3/02

(57) ABSTRACT

A method of approximating delay for postsynaptic potentials includes receiving a postsynaptic potential. The method further includes filtering the postsynaptic potential to approximate a delayed delivery of the postsynaptic potential.

### BACKGROUND

1. Field

Certain aspects of the present disclosure generally relate to neural system engineering and, more particularly, to systems and methods for effecting delay for postsynaptic potentials in a neural network.

2. Background

An artificial neural network, which may comprise an interconnected group of artificial neurons (i.e., neuron models), is a computational device or represents a method to be performed by a computational device. Artificial neural networks may have corresponding structure and/or function with biological neural networks. However, artificial neural networks may provide innovative and useful computational techniques for certain applications in which traditional computational techniques are cumbersome, impractical, or inadequate. Because artificial neural networks can infer a function from observations, such networks are particularly useful in applications where the complexity of the task or data makes the design of the function by conventional techniques burdensome.

Excitatory and inhibitory postsynaptic potentials (PSPs) are typically modeled as a difference of two exponential decays (in general, a linear combination of one or more exponentials with different time constants). Furthermore, dendrites and/or axons (or synaptic connections) are typically modeled as having delays. These delays effectively shift the postsynaptic potentials (postsynaptic potentials) so that the waveform at the postsynaptic neuron is time-shifted. Such modeling of postsynaptic potentials uses input buffers and fan-in/fan out event generation and is therefore computationally expensive and burdensome.

### SUMMARY

In an aspect of the present disclosure, a method for approximating a delay for postsynaptic potentials is disclosed. The method includes receiving a postsynaptic potential. The method further includes filtering the postsynaptic potential to approximate a delayed delivery of the postsynaptic potential.

In another aspect of the present disclosure, an apparatus for approximating a delay for postsynaptic potentials is disclosed. The apparatus includes a memory and a processor coupled to the memory. The processor is configured to receive a postsynaptic potential. The processor is further configured to filter the postsynaptic potential to approximate a delayed delivery of the postsynaptic potential.

In still another aspect, an apparatus for approximating a delay for postsynaptic potentials is disclosed. The apparatus comprises means for receiving a postsynaptic potential. The apparatus also has means for filtering the postsynaptic potential to approximate a delayed delivery of the postsynaptic potential.

In yet another aspect of the present disclosure, a computer program product is disclosed. The computer program product includes a non-transitory computer readable medium having encoded thereon program code. The program code includes program code to receive a postsynaptic potential. The program code further includes program code to filter the postsynaptic potential to approximate a delayed delivery of the postsynaptic potential.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example network of neurons in accordance with certain aspects of the present disclosure.

FIG. 2 illustrates an example of a processing unit (neuron) of a computational network (neural system or neural network) in accordance with certain aspects of the present disclosure.

FIG. 3 illustrates an example of spike-timing dependent plasticity (STDP) curve in accordance with certain aspects of the present disclosure.

FIG. 4 illustrates an example of a positive regime and a negative regime for defining behavior of a neuron model in accordance with certain aspects of the present disclosure.

FIGS. 5A-5E are graphs illustrating postsynaptic potentials with various delays in accordance with aspects of the present disclosure.

FIG. 6 is a block diagram illustrating a method for approximating a delayed postsynaptic potential in accordance with aspects of the present disclosure.

FIG. 7 illustrates an example implementation of designing a neural network using a general-purpose processor in accordance with certain aspects of the present disclosure.

FIG. 8 illustrates an example implementation of designing a neural network where a memory may be interfaced with individual distributed processing units in accordance with certain aspects of the present disclosure.

FIG. 9 illustrates an example implementation of designing a neural network based on distributed memories and distributed processing units in accordance with certain aspects of the present disclosure.

FIG. 10 illustrates an example implementation of a neural network in accordance with certain aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

### An Example Neural System, Training and Operation

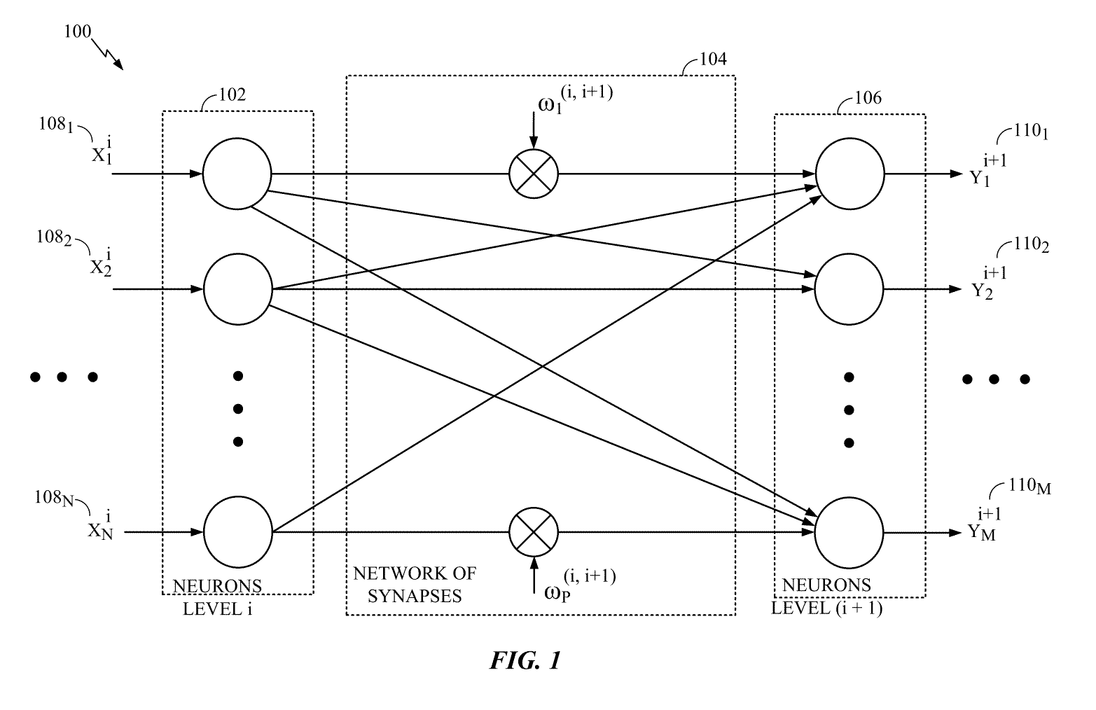

FIG. 1 illustrates an example artificial neural system 100 with multiple levels of neurons in accordance with certain aspects of the present disclosure. The neural system 100 may have a level of neurons 102 connected to another level of neurons 106 through a network of synaptic connections 104 (i.e., feed-forward connections). For simplicity, only two levels of neurons are illustrated in FIG. 1, although fewer or more levels of neurons may exist in a neural system. It should be noted that some of the neurons may connect to other neurons of the same layer through lateral connections. Furthermore, some of the neurons may connect back to a neuron of a previous layer through feedback connections.

As illustrated in FIG. 1, each neuron in the level 102 may receive an input signal 108 that may be generated by neurons of a previous level (not shown in FIG. 1). The signal 108 may represent an input current of the level 102 neuron. This current may be accumulated on the neuron membrane to charge a membrane potential. When the membrane potential reaches its threshold value, the neuron may fire and generate an output spike to be transferred to the next level of neurons (e.g., the level 106). In some modeling approaches, the neuron may continuously transfer a signal to the next level of neurons. This signal is typically a function of the membrane potential. Such behavior can be emulated or simulated in hardware and/or software, including analog and digital implementations such as those described below.

In biological neurons, the output spike generated when a neuron fires is referred to as an action potential. This electrical signal is a relatively rapid, transient, nerve impulse, having an amplitude of roughly 100 mV and a duration of about 1 ms. In a particular embodiment of a neural system having a series of connected neurons (e.g., the transfer of spikes from one level of neurons to another in FIG. 1), every action potential has basically the same amplitude and duration, and thus, the information in the signal may be represented only by the frequency and number of spikes, or the time of spikes, rather than by the amplitude. The information carried by an action potential may be determined by the spike, the neuron that spiked, and the time of the spike relative to other spike or spikes. The importance of the spike may be determined by a weight applied to a connection between neurons, as explained below.

The transfer of spikes from one level of neurons to another may be achieved through the network of synaptic connections (or simply “synapses”) 104, as illustrated in FIG. 1. Relative to the synapses 104, neurons of level 102 may be considered presynaptic neurons and neurons of level 106 may be considered postsynaptic neurons. The synapses 104 may receive output signals (i.e., spikes) from the level 102 neurons and scale those signals according to adjustable synaptic weights w₁^{(i,i+1)}, . . . , w_{P}^{(i,i+1)} where P is a total number of synaptic connections between the neurons of levels 102 and 106 and i is an indicator of the neuron level. In the example of FIG. 1, i represents neuron level 102 and i+1 represents neuron level 106. Further, the scaled signals may be combined as an input signal of each neuron in the level 106. Every neuron in the level 106 may generate output spikes 110 based on the corresponding combined input signal. The output spikes 110 may be transferred to another level of neurons using another network of synaptic connections (not shown in FIG. 1).

Biological synapses can mediate either excitatory or inhibitory (hyperpolarizing) actions in postsynaptic neurons and can also serve to amplify neuronal signals. Excitatory signals depolarize the membrane potential (i.e., increase the membrane potential with respect to the resting potential). If enough excitatory signals are received within a certain time period to depolarize the membrane potential above a threshold, an action potential occurs in the postsynaptic neuron. In contrast, inhibitory signals generally hyperpolarize (i.e., lower) the membrane potential. Inhibitory signals, if strong enough, can counteract the sum of excitatory signals and prevent the membrane potential from reaching a threshold. In addition to counteracting synaptic excitation, synaptic inhibition can exert powerful control over spontaneously active neurons. A spontaneously active neuron refers to a neuron that spikes without further input, for example due to its dynamics or a feedback. By suppressing the spontaneous generation of action potentials in these neurons, synaptic inhibition can shape the pattern of firing in a neuron, which is generally referred to as sculpturing. The various synapses 104 may act as any combination of excitatory or inhibitory synapses, depending on the behavior desired.

The neural system 100 may be emulated by a general purpose processor, a digital signal processor (DSP), an application specific integrated circuit (ASIC), a field programmable gate array (FPGA) or other programmable logic device (PLD), discrete gate or transistor logic, discrete hardware components, a software module executed by a processor, or any combination thereof. The neural system 100 may be utilized in a large range of applications, such as image and pattern recognition, machine learning, motor control, and alike. Each neuron in the neural system 100 may be implemented as a neuron circuit. The neuron membrane charged to the threshold value initiating the output spike may be implemented, for example, as a capacitor that integrates an electrical current flowing through it.

In an aspect, the capacitor may be eliminated as the electrical current integrating device of the neuron circuit, and a smaller memristor element may be used in its place. This approach may be applied in neuron circuits, as well as in various other applications where bulky capacitors are utilized as electrical current integrators. In addition, each of the synapses 104 may be implemented based on a memristor element, where synaptic weight changes may relate to changes of the memristor resistance. With nanometer feature-sized memristors, the area of a neuron circuit and synapses may be substantially reduced, which may make implementation of a large-scale neural system hardware implementation more practical.

Functionality of a neural processor that emulates the neural system 100 may depend on weights of synaptic connections, which may control strengths of connections between neurons. The synaptic weights may be stored in a non-volatile memory in order to preserve functionality of the processor after being powered down. In an aspect, the synaptic weight memory may be implemented on a separate external chip from the main neural processor chip. The synaptic weight memory may be packaged separately from the neural processor chip as a replaceable memory card. This may provide diverse functionalities to the neural processor, where a particular functionality may be based on synaptic weights stored in a memory card currently attached to the neural processor.

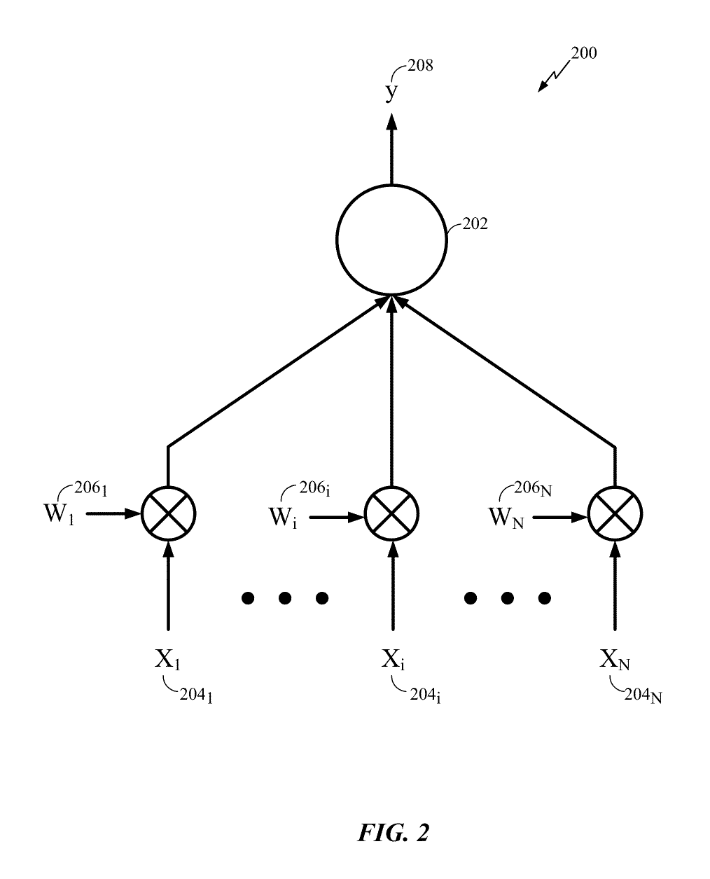

FIG. 2 illustrates an exemplary diagram 200 of a processing unit (e.g., a neuron or neuron circuit) 202 of a computational network (e.g., a neural system or a neural network) in accordance with certain aspects of the present disclosure. For example, the neuron 202 may correspond to any of the neurons of levels 102 and 106 from FIG. 1. The neuron 202 may receive multiple input signals 204₁-204_{N} (X₁-X_{N}), which may be signals external to the neural system, or signals generated by other neurons of the same neural system, or both. The input signal may be a current, a conductance, a voltage, a real-valued, and/or a complex-valued. The input signal may comprise a numerical value with a fixed-point or a floating-point representation. These input signals may be delivered to the neuron 202 through synaptic connections that scale the signals according to adjustable synaptic weights 206₁-206_{N} (W₁-W_{N}), where N may be a total number of input connections of the neuron 202.

The neuron 202 may combine the scaled input signals and use the combined scaled inputs to generate an output signal 208 (i.e., a signal Y). The output signal 208 may be a current, a conductance, a voltage, a real-valued and/or a complex-valued. The output signal may be a numerical value with a fixed-point or a floating-point representation. The output signal 208 may be then transferred as an input signal to other neurons of the same neural system, or as an input signal to the same neuron 202, or as an output of the neural system.

The processing unit (neuron) 202 may be emulated by an electrical circuit, and its input and output connections may be emulated by electrical connections with synaptic circuits. The processing unit 202 and its input and output connections may also be emulated by a software code. The processing unit 202 may also be emulated by an electric circuit, whereas its input and output connections may be emulated by a software code. In an aspect, the processing unit 202 in the computational network may be an analog electrical circuit. In another aspect, the processing unit 202 may be a digital electrical circuit. In yet another aspect, the processing unit 202 may be a mixed-signal electrical circuit with both analog and digital components. The computational network may include processing units in any of the aforementioned forms. The computational network (neural system or neural network) using such processing units may be utilized in a large range of applications, such as image and pattern recognition, machine learning, motor control, and the like.

During the course of training a neural network, synaptic weights (e.g., the weights w₁^{(i,i+1)}, . . . , w_{P}^{(i,i+1)} from FIG. 1 and/or the weights 206₁-206_{N} from FIG. 2) may be initialized with random values and increased or decreased according to a learning rule. Those skilled in the art will appreciate that examples of the learning rule include, but are not limited to the spike-timing-dependent plasticity (STDP) learning rule, the Hebb rule, the Oja rule, the Bienenstock-Copper-Munro (BCM) rule, etc. In certain aspects, the weights may settle or converge to one of two values (i.e., a bimodal distribution of weights). This effect can be utilized to reduce the number of bits for each synaptic weight, increase the speed of reading and writing from/to a memory storing the synaptic weights, and to reduce power and/or processor consumption of the synaptic memory.

### Synapse Type

In hardware and software models of neural networks, the processing of synapse related functions can be based on synaptic type. Synapse types may include non-plastic synapses (no changes of weight and delay), plastic synapses (weight may change), structural delay plastic synapses (weight and delay may change), fully plastic synapses (weight, delay and connectivity may change), and variations thereupon (e.g., delay may change, but no change in weight or connectivity). The advantage of this is that processing can be subdivided. For example, non-plastic synapses may not utilize plasticity functions to be executed (or waiting for such functions to complete). Similarly, delay and weight plasticity may be subdivided into operations that may operate together or separately, in sequence or in parallel. Different types of synapses may have different lookup tables or formulas and parameters for each of the different plasticity types that apply. Thus, the methods would access the relevant tables, formulas, or parameters for the synapse's type.

There are further implications of the fact that spike-timing dependent structural plasticity may be executed independently of synaptic plasticity. Structural plasticity may be executed even if there is no change to weight magnitude (e.g., if the weight has reached a minimum or maximum value, or it is not changed due to some other reason) s structural plasticity (i.e., an amount of delay change) may be a direct function of pre-post spike time difference. Alternatively, it may be set as a function of the weight change amount or based on conditions relating to bounds of the weights or weight changes. For example, a synapse delay may change only when a weight change occurs or if weights reach zero but not if they are at a maximum value. However, it may be advantageous to have independent functions so that these processes can be parallelized reducing the number and overlap of memory accesses.

### Determination of Synaptic Plasticity

Neuroplasticity (or simply “plasticity”) is the capacity of neurons and neural networks in the brain to change their synaptic connections and behavior in response to new information, sensory stimulation, development, damage, or dysfunction. Plasticity is important to learning and memory in biology, as well as for computational neuroscience and neural networks. Various forms of plasticity have been studied, such as synaptic plasticity (e.g., according to the Hebbian theory), spike-timing-dependent plasticity (STDP), non-synaptic plasticity, activity-dependent plasticity, structural plasticity and homeostatic plasticity.

STDP is a learning process that adjusts the strength of synaptic connections between neurons. The connection strengths are adjusted based on the relative timing of a particular neuron's output and received input spikes (i.e., action potentials). Under the STDP process, long-term potentiation (LTP) may occur if an input spike to a certain neuron tends, on average, to occur immediately before that neuron's output spike. Then, that particular input is made somewhat stronger. On the other hand, long-term depression (LTD) may occur if an input spike tends, on average, to occur immediately after an output spike. Then, that particular input is made somewhat weaker, and hence the name “spike-timing-dependent plasticity.” Consequently, inputs that might be the cause of the postsynaptic neuron's excitation are made even more likely to contribute in the future, whereas inputs that are not the cause of the postsynaptic spike are made less likely to contribute in the future. The process continues until a subset of the initial set of connections remains, while the influence of all others is reduced to an insignificant level.

Because a neuron generally produces an output spike when many of its inputs occur within a brief period (i.e., being cumulative sufficient to cause the output), the subset of inputs that typically remains includes those that tended to be correlated in time. In addition, because the inputs that occur before the output spike are strengthened, the inputs that provide the earliest sufficiently cumulative indication of correlation will eventually become the final input to the neuron.

The STDP learning rule may effectively adapt a synaptic weight of a synapse connecting a presynaptic neuron to a postsynaptic neuron as a function of time difference between spike time tₚᵣₑ of the presynaptic neuron and spike time tₚₒₛₜ of the postsynaptic neuron (i.e., t=tₚₒₛₜ−tₚᵣₑ). A typical formulation of the STDP is to increase the synaptic weight (i.e., potentiate the synapse) if the time difference is positive (the presynaptic neuron fires before the postsynaptic neuron), and decrease the synaptic weight (i.e., depress the synapse) if the time difference is negative (the postsynaptic neuron fires before the presynaptic neuron).

In the STDP process, a change of the synaptic weight over time may be typically achieved using an exponential decay, as given by:

$$Δ w ( t ) = \{ \begin{matrix}{a}_{+} {e}^{- t / {k}_{+}} + μ , & t > 0 \\ {a}_{-} {e}^{t / {k}_{-}} & t < 0\end{matrix} , \qquad ( 1 )$$

where k₊ and k₋τ_{sign(Δt)} are time constants for positive and negative time difference, respectively, a₊ and a₋ are corresponding scaling magnitudes, and μ is an offset that may be applied to the positive time difference and/or the negative time difference.

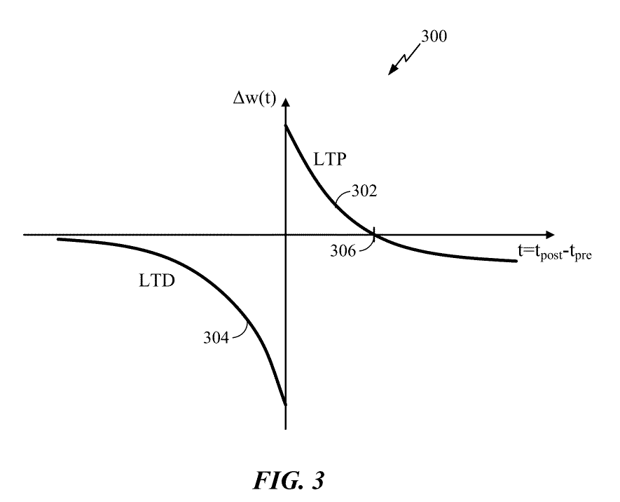

FIG. 3 illustrates an exemplary diagram 300 of a synaptic weight change as a function of relative timing of presynaptic and postsynaptic spikes in accordance with the STDP. If a presynaptic neuron fires before a postsynaptic neuron, then a corresponding synaptic weight may be increased, as illustrated in a portion 302 of the graph 300. This weight increase can be referred to as an LTP of the synapse. It can be observed from the graph portion 302 that the amount of LTP may decrease roughly exponentially as a function of the difference between presynaptic and postsynaptic spike times. The reverse order of firing may reduce the synaptic weight, as illustrated in a portion 304 of the graph 300, causing an LTD of the synapse.

As illustrated in the graph 300 in FIG. 3, a negative offset μ may be applied to the LTP (causal) portion 302 of the STDP graph. A point of cross-over 306 of the x-axis (y=0) may be configured to coincide with the maximum time lag for considering correlation for causal inputs from layer i−1. In the case of a frame-based input (i.e., an input that is in the form of a frame of a particular duration comprising spikes or pulses), the offset value μ can be computed to reflect the frame boundary. A first input spike (pulse) in the frame may be considered to decay over time either as modeled by a postsynaptic potential directly or in terms of the effect on neural state. If a second input spike (pulse) in the frame is considered correlated or relevant to a particular time frame, then the relevant times before and after the frame may be separated at that time frame boundary and treated differently in plasticity terms by offsetting one or more parts of the STDP curve such that the value in the relevant times may be different (e.g., negative for greater than one frame and positive for less than one frame). For example, the negative offset μ may be set to offset LTP such that the curve actually goes below zero at a pre-post time greater than the frame time and it is thus part of LTD instead of LTP.

### Neuron Models and Operation

There are some general principles for designing a useful spiking neuron model. A good neuron model may have rich potential behavior in terms of two computational regimes: coincidence detection and functional computation. Moreover, a good neuron model should have two elements to allow temporal coding: arrival time of inputs affects output time and coincidence detection can have a narrow time window. Finally, to be computationally attractive, a good neuron model may have a closed-form solution in continuous time and stable behavior including near attractors and saddle points. In other words, a useful neuron model is one that is practical and that can be used to model rich, realistic and biologically-consistent behaviors, as well as be used to both engineer and reverse engineer neural circuits.

A neuron model may depend on events, such as an input arrival, output spike or other event whether internal or external. To achieve a rich behavioral repertoire, a state machine that can exhibit complex behaviors may be desired. If the occurrence of an event itself, separate from the input contribution (if any), can influence the state machine and constrain dynamics subsequent to the event, then the future state of the system is not only a function of a state and input, but rather a function of a state, event, and input.

In an aspect, a neuron n may be modeled as a spiking leaky-integrate-and-fire neuron with a membrane voltage vₙ(t) governed by the following dynamics:

$$\frac{d {v}_{n} ( t )}{d t} = α {v}_{n} ( t ) + β {\sum }_{m} {w}_{m , n} {y}_{m} ( t - Δ {t}_{m , n} ) , \qquad ( 2 )$$

where α and β are parameters, w_{m,n} is a synaptic weight for the synapse connecting a presynaptic neuron m to a postsynaptic neuron n, and yₘ(t) is the spiking output of the neuron m that may be delayed by dendritic or axonal delay according to Δt_{m,n} until arrival at the neuron n's soma.

It should be noted that there is a delay from the time when sufficient input to a postsynaptic neuron is established until the time when the postsynaptic neuron actually fires. In a dynamic spiking neuron model, such as Izhikevich's simple model, a time delay may be incurred if there is a difference between a depolarization threshold vₜ and a peak spike voltage Vₚₑₐₖ. For example, in the simple model, neuron soma dynamics can be governed by the pair of differential equations for voltage and recovery, i.e.:

$$\begin{matrix}\frac{d v}{d t} = ( k ( v - {v}_{t} ) ( v - {v}_{r} ) - u + I ) / C , & ( 3 ) \\ \frac{d u}{d t} = a ( b ( v - {v}_{r} ) - u ) . & ( 4 )\end{matrix}$$

where v is a membrane potential, u is a membrane recovery variable, k is a parameter that describes time scale of the membrane potential v, a is a parameter that describes time scale of the recovery variable u, b is a parameter that describes sensitivity of the recovery variable u to the sub-threshold fluctuations of the membrane potential v, vᵣ is a membrane resting potential, I is a synaptic current, and C is a membrane's capacitance. In accordance with this model, the neuron is defined to spike when v>vₚₑₐₖ.

### Hunzinger Cold Model

The Hunzinger Cold neuron model is a minimal dual-regime spiking linear dynamical model that can reproduce a rich variety of neural behaviors. The model's one- or two-dimensional linear dynamics can have two regimes, wherein the time constant (and coupling) can depend on the regime. In the sub-threshold regime, the time constant, negative by convention, represents leaky channel dynamics generally acting to return a cell to rest in a biologically-consistent linear fashion. The time constant in the supra-threshold regime, positive by convention, reflects anti-leaky channel dynamics generally driving a cell to spike while incurring latency in spike-generation.

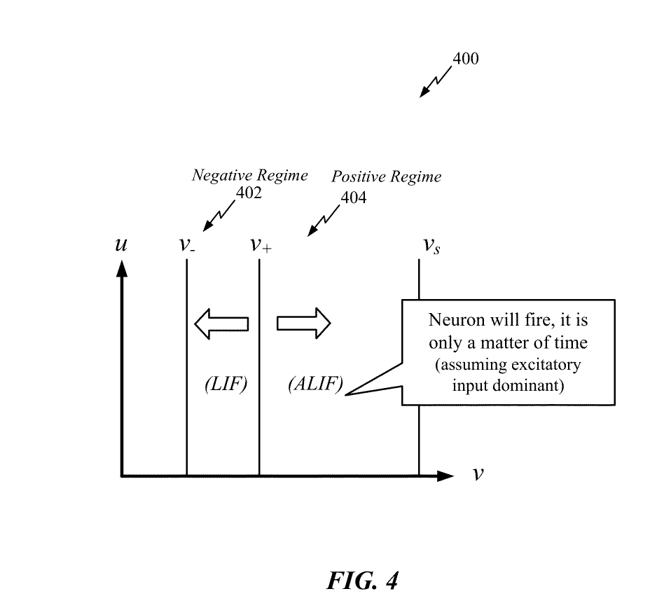

As illustrated in FIG. 4, the dynamics of the model 400 may be divided into two (or more) regimes. These regimes may be called the negative regime 402 (also interchangeably referred to as the leaky-integrate-and-fire (LIF) regime, not to be confused with the LIF neuron model) and the positive regime 404 (also interchangeably referred to as the anti-leaky-integrate-and-fire (ALIF) regime, not to be confused with the ALIF neuron model). In the negative regime 402, the state tends toward rest (v₋) at the time of a future event. In this negative regime, the model generally exhibits temporal input detection properties and other sub-threshold behavior. In the positive regime 404, the state tends toward a spiking event (vₛ). In this positive regime, the model exhibits computational properties, such as incurring a latency to spike depending on subsequent input events. Formulation of dynamics in terms of events and separation of the dynamics into these two regimes are fundamental characteristics of the model.

Linear dual-regime bi-dimensional dynamics (for states v and u) may be defined by convention as:

$$\begin{matrix}{τ}_{ρ} \frac{d v}{d t} = v + {q}_{ρ} & ( 5 ) \\ - {τ}_{u} \frac{d u}{d t} = u + r & ( 6 )\end{matrix}$$

where q_{ρ} and r are the linear transformation variables for coupling.

The symbol ρ is used herein to denote the dynamics regime with the convention to replace the symbol ρ with the sign “−” or “+” for the negative and positive regimes, respectively, when discussing or expressing a relation for a specific regime.

The model state is defined by a membrane potential (voltage) v and recovery current u. In basic form, the regime is essentially determined by the model state. There are subtle, but important aspects of the precise and general definition, but for the moment, consider the model to be in the positive regime 404 if the voltage v is above a threshold (v₊) and otherwise in the negative regime 402.

The regime-dependent time constants include τ₋ which is the negative regime time constant, and τ₊ which is the positive regime time constant. The recovery current time constants τᵤ is typically independent of regime. For convenience, the negative regime time constant τ₋ is typically specified as a negative quantity to reflect decay so that the same expression for voltage evolution may be used as for the positive regime in which the exponent and τ₊ will generally be positive, as will be τᵤ.

The dynamics of the two state elements may be coupled at events by transformations offsetting the states from their null-clines, where the transformation variables are:

q_{ρ}=−τ_{ρ}βu−v_{ρ} (7)

r=δ(v+Σ) (8)

where δ, ε, β and v₋, v₊ are parameters. The two values for v_{ρ} are the base for reference voltages for the two regimes. The parameter v₋ is the base voltage for the negative regime, and the membrane potential will generally decay toward v₋ in the negative regime. The parameter v₊ is the base voltage for the positive regime, and the membrane potential will generally tend away from v₊ in the positive regime.

The null-clines for v and u are given by the negative of the transformation variables q_{ρ} and r, respectively. The parameter δ is a scale factor controlling the slope of the u null-cline. The parameter ε is typically set equal to −v₋. The parameter β is a resistance value controlling the slope of the v null-clines in both regimes. The τ_{ρ} time-constant parameters control not only the exponential decays, but also the null-cline slopes in each regime separately.

The model may be defined to spike when the voltage v reaches a value v_{S}. Subsequently, the state may be reset at a reset event (which may be one and the same as the spike event):

v=\hat{v}₋ (9)

u=u+Δu (10)

where \hat{v}₋ and Δu are parameters. The reset voltage \hat{v}₋ is typically set to v₋.

By a principle of momentary coupling, a closed form solution is possible not only for state (and with a single exponential term), but also for the time to reach a particular state. The close form state solutions are:

$$\begin{matrix}v ( t + Δ t ) = ( v ( t ) + {q}_{ρ} ) {e}^{\frac{Δ t}{{τ}_{ρ}}} - {q}_{ρ} & ( 11 ) \\ u ( t + Δ t ) = ( u ( t ) + r ) {e}^{- \frac{Δ t}{{τ}_{u}}} - r & ( 12 )\end{matrix}$$

Therefore, the model state may be updated only upon events, such as an input (presynaptic spike) or output (postsynaptic spike). Operations may also be performed at any particular time (whether or not there is input or output).

Moreover, by the momentary coupling principle, the time of a postsynaptic spike may be anticipated so the time to reach a particular state may be determined in advance without iterative techniques or Numerical Methods (e.g., the Euler numerical method). Given a prior voltage state v₀, the time delay until voltage state v_{f} is reached is given by:

$$Δ t = {τ}_{ρ} log \frac{{v}_{f} + {q}_{ρ}}{{v}_{0} + {q}_{ρ}} \qquad ( 13 )$$

If a spike is defined as occurring at the time the voltage state v reaches v_{S}, then the closed-form solution for the amount of time, or relative delay, until a spike occurs as measured from the time that the voltage is at a given state v is:

$$Δ {t}_{S} = \{ \begin{matrix}{τ}_{+} log \frac{{v}_{S} + {q}_{+}}{v + {q}_{+}} & if v > {\hat{v}}_{+} \\ ∞ & otherwise\end{matrix} \qquad ( 14 )$$

where \hat{v}₊ is typically set to parameter v₊, although other variations may be possible.

The above definitions of the model dynamics depend on whether the model is in the positive or negative regime. As mentioned, the coupling and the regime ρ may be computed upon events. For purposes of state propagation, the regime and coupling (transformation) variables may be defined based on the state at the time of the last (prior) event. For purposes of subsequently anticipating spike output time, the regime and coupling variable may be defined based on the state at the time of the next (current) event.

There are several possible implementations of the Cold model, and executing the simulation, emulation or model in time. This includes, for example, event-update, step-event update, and step-update modes. An event update is an update where states are updated based on events or “event update” (at particular moments). A step update is an update when the model is updated at intervals (e.g., 1 ms). This does not necessarily use iterative methods or Numerical methods. An event-based implementation is also possible at a limited time resolution in a step-based simulator by only updating the model if an event occurs at or between steps or by “step-event” update.

### Equivalent Delay by Shaping Postsynaptic Potentials

Aspects of the present disclosure are directed to modeling dendritic and/or axonal delays. Modeling delays may be beneficial in improving efficiency and processing costs associated with emulating neural dynamics. For example, if an axon/dendrite/synapse delay could be reduced to zero, a presynaptic spike event and a postsynaptic input event could become one and the same. In a conventional simulation framework, this may reduce the number of input buffer (time bins) used. In an event-based framework, this may reduce fan-in/fan-out event generation.

Moreover, by determining an approximation for the delays, spike events may be arbitrarily aligned in time and processed in parallel or distributed in time to avoid load bottlenecks. Accordingly, aspects of the present disclosure are directed to methods by which a delayed postsynaptic potential waveform may be generated without delay or may be generated with arbitrary delay. In some aspects, any desired delayed postsynaptic potential waveform may be determined with a linear scaling of an exponential component by the desired delay. Thus, a user may significantly reduce delay in spike processing without dramatically changing the behavior of spiking neurons and a network as a whole.

A postsynaptic potential for an input k may be modeled as a linear combination of exponentials with different time decay time constants ° r_{k,j} where each exponential component decays as,

i_{k,j}(t_{f})=i_{k,j}(t₀)e^{-(t}^{_{f}}^{-t}^{₀}^{)/τ}^{_{k,j}} (15)

A postsynaptic potential begins when the first component of that postsynaptic potential is at t_{k,0}. This time may be delayed due to propagation time along the axon, dendrite or synapse connection that conveys input k,

t_{k,0}=tₖ+Δtₖ, (16)

where Δtₖ is a connection delay. Furthermore, each component may begin at a different time offset δt_{k,j}, relative to the earliest component,

i_{k,j}(t)=a_{k,j}u(t−t_{k,0}−δt_{k,j}) (17)

where a_{k,j} is a scalar constant. Accordingly, each postsynaptic potential may be expressed as a sum of components,

$${i}_{k} ( t ) = {\sum }_{j}^{N} {i}_{k , j} ( t ) \qquad ( 18 )$$

In accordance with aspects of the present disclosure, postsynaptic potentials may be expressed using the same set of components to generalize that τ_{k,j}=τⱼ. Consequently, the number of components for determining an overall postsynaptic input may be reduced. Individual input values a_{k,j} may be applied to appropriate components according to an input time t_{k,0} and component offsets δt_{k,j}. Thus, the overall effect of the postsynaptic potential may be modeled over time by looking forward or backward in time for each component.

The overall contribution of all postsynaptic potentials (e.g., the combination of components at a particular time) may also be found at a different time,

$$i ( {t}_{f} ) = {\sum }_{j}^{N} {i}_{j} ( {t}_{0} ) {e}^{- ( {t}_{f} - {t}_{0} ) / {τ}_{j}} \qquad ( 19 )$$

In accordance with aspects of the present disclosure, a postsynaptic potential resembling a delayed postsynaptic potential may be generated by reshaping the postsynaptic potential. For purposes of clarity, the term reshaping includes shaping or otherwise modifying a shape of a curve of a postsynaptic potential. Generating a delayed postsynaptic potential by reshaping may be beneficial as it may improve system efficiency and provide increased flexibility of neural processing. For example, the connection delay Δtₖ (including setting delay to zero) may be arbitrarily changed by an amount Δt without impacting the overall input P. The input may be applied after a time delay Δtₖ−Δt instead of Δtₖ and the waveform of the postsynaptic potential may be changed to resemble a delayed postsynaptic potential, as if the postsynaptic potential was delayed by a further Δt.

In some aspects, the postsynaptic potential may be reshaped using one or more additional exponential components. In some aspects, the postsynaptic potential may be reshaped by suppression of a subset of input. For example, the postsynaptic potential may be reshaped by suppressing the excitatory postsynaptic potential (EPSP) or by suppressing inhibitory postsynaptic potential (IPSP) or another subset of the input postsynaptic potentials.

In some aspects, the addition of one or more exponential components may be made to resemble the same postsynaptic potential except delayed by Δt. If, for example, there are N components for basic postsynaptic potential shaping and M additional components for reshaping,

$$\begin{matrix} {i}^{′} ( t ) ≅ i ( t - Δ t ) \\ or , & ( 20 ) \\ {\sum }_{j}^{N} {i}_{j} ( {t}_{0} ) {e}^{- ( {t}_{f} - {t}_{o} ) / {τ}_{j}} + {\sum }_{q}^{M} {i}_{q}^{′} ( {t}_{0} ) {e}^{- ( {t}_{f} - {t}_{o} ) / {τ}_{q}^{′}} = {\sum }_{j}^{N} {i}_{j} ( {t}_{0} ) {e}^{- ( {t}_{f} - {t}_{o} - Δ t ) / {τ}_{j}} & ( 21 )\end{matrix}$$

which yields

$${\sum }_{q}^{M} {i}_{q}^{′} ( {t}_{0} ) {e}^{- ( {t}_{f} - {t}_{o} ) / {τ}_{q}^{′}} = {\sum }_{j}^{N} {i}_{j} ( {t}_{0} ) {e}^{- ( {t}_{f} - {t}_{o} ) / {τ}_{j}} ( {e}^{Δ t / {τ}_{j}} - 1 ) \qquad ( 22 )$$

In some aspects, the same set of one or more reshaping components (i.e., M) may be used to determine a set of input postsynaptic potentials using the same set of time constants τ_{q}′. The scalar input values i_{q}′(t₀) that will yield the desired Δt may be determined. For example, where there is one reshaping component (M=1), or where each is considered using only one reshaping component for each postsynaptic potential,

$${i}_{q}^{′} ( {t}_{0} ) = {e}^{( {i}_{f} - {i}_{o} ) / {i}_{q}^{′}} {\sum }_{j}^{N} {i}_{j} ( {t}_{0} ) {e}^{- ( {i}_{f} - {i}_{o} ) / {i}_{j}} ( {e}^{Δ i / {i}_{j}} - 1 ) \qquad ( 23 )$$

However, this is merely exemplary, and the scalar input values i_{q}′(t₀) that will yield the desired Δt may likewise be determined when there are multiple reshaping components (M>1).

The scalar input values i_{q}′(t₀) may be selected according to a desired delay shift. For example, the delay shift may be relatively constant across time, i.e. values of t_{f}−t₀. In some cases, the delay shift may be relatively constant for a time period in which the postsynaptic potential is significantly non-zero (e.g., when the PSP is above 0.9). Accordingly, in one exemplary configuration, the scalar input values l_{q}′(t₀) may be selected to satisfy the time period in which the postsynaptic potential is significantly non-zero.

In some aspects, the scalar input values i_{q}′(t₀) may be selected according to a median value or a value for the peak time point. For example, the average scalar input values selected to satisfy a median for the peak time point may be given by

$${i}_{q}^{′} ( {t}_{0} , t ) = {e}^{t / {τ}_{i}^{′}} {\sum }_{j}^{N} {i}_{j} ( {t}_{0} ) {e}^{- t / {τ}_{j}} ( {e}^{Δ t / {τ}_{j}} - 1 ) \qquad ( 24 )$$

Various additional alternatives are possible in keeping with the principle that the initial input be determined to obtain the desired time shift, including but not limited to, approximating the initial input to determine the desired time shift. That is, if Δt is assumed to be small relative to τⱼ's, then by power series expansion of e^{x}=ΣZₙ₋₁^{∞}xₛ/n1, for M=1,

$$\begin{matrix}{i}_{q}^{′} ( {t}_{0} , t ) ≅ α ( t ) Δ t \\ where & ( 25 ) \\ α ( t ) ≡ {\sum }_{j}^{N} \frac{{i}_{j} ( {t}_{0} )}{{τ}_{j}} {e}^{t ( \frac{1}{{τ}_{q}^{′}} - \frac{1}{{τ}_{j}} )} & ( 26 )\end{matrix}$$

In some aspects, reshaping a postsynaptic potential may comprise suppressing and/or selecting a subset of input values. For example, reshaping may include selecting (or suppressing) input values based on whether a postsynaptic potential is excitatory or inhibitory. If an input is excitatory, then only a positive value of the reshaped postsynaptic potential (i.e., excitatory postsynaptic potential (EPSP)) may be relevant. In other words, the scalar input values may be characterized as follows:

$${i}^{′} ( t ) = \vert {\sum }_{j}^{N} {i}_{j} ( {t}_{0} ) {e}^{- ( {t}_{f} - {t}_{u} ) / {τ}_{j}} + {\sum }_{q}^{M} {i}_{q}^{′} ( {t}_{0} ) {e}^{- ( {t}_{f} - {t}_{u} ) / {τ}_{u}^{′}} \vert \qquad ( 27 )$$

Conversely, for an inhibitory postsynaptic potential (IPSP), the scalar input values may be characterized by:

$${i}^{′} ( t ) = - \vert - {\sum }_{j}^{N} {i}_{j} ( {t}_{0} ) {e}^{- ( {t}_{f} - {t}_{0} ) / {τ}_{j}} - {\sum }_{q}^{M} {i}_{q}^{′} ( {t}_{0} ) {e}^{- ( {t}_{f} - {t}_{0} ) / {τ}_{q}^{′}} \vert \qquad ( 28 )$$

This means excitatory postsynaptic potentials and inhibitory postsynaptic potentials may be generated by separately shaping and reshaping components or where one or more of the components is shared and the other components are separate.

A shaped postsynaptic potential may be compared to a delayed postsynaptic potential it is meant to resemble in various ways. For example, the shaped PSP may be compared to a delayed PSP based on a total input contribution, peak value or like techniques. Using such metrics, two or more postsynaptic potentials may be compared to determine how closely they resemble one another. In addition, such comparison metrics may also be used to reshape a postsynaptic potential such that it more closely resembles an input postsynaptic potential.

In some aspects, a reshaped postsynaptic potential that has the same total input contribution or area under the postsynaptic potential may be determined. The integral of total input over time is given by,

$$\int i ( t + x ) d x = {\sum }_{j}^{N} {i}_{j} ( t ) {τ}_{j} ( 1 - {e}^{- x / {τ}_{j}} ) \qquad ( 29 )$$

the future integrated input may be evaluated as,

$${\int }_{0}^{∞} i ( t + x ) d x = {\sum }_{j}^{N} {i}_{j} ( t ) {τ}_{j} \qquad ( 30 )$$

In some aspects, a reshaped postsynaptic potential that has the same peak value may be determined. The peak may be determined by solving for the time at which the derivative is zero,

$$\frac{d }{d x} i ( t + x ) = {\sum }_{j}^{N} \frac{{i}_{j} ( t )}{{τ}_{j}} {e}^{- x / {τ}_{j}} \qquad ( 31 )$$

In one exemplary configuration, two exponential components (i.e., N=2) of a reshaped PSP having the same peak value may be determined. This may be done by solving the above derivative equal to zero, which yields

$$Δ {t}_{peak} = - \frac{log [ - ( \frac{{τ}_{1}}{{τ}_{2}} ) \frac{{i}_{2} ( t )}{{i}_{1} ( t )} ]}{( \frac{1}{{τ}_{1}} - \frac{1}{{τ}_{2}} )} \qquad ( 32 )$$

In some aspects, additional components may be determined by solving the derivative equation (31) using other methods, including but not limited to, numerical or search methods or approximations.

In some aspects, a reshaped postsynaptic potential that has the same shape in terms of breadth may be determined. The breadth or shape may be characterized, for example, by the integral of the postsynaptic potential value weighted by the absolute time difference from the peak, which may be given by

$${\int }_{n}^{∞} \vert x - Δ {t}_{peak} \vert i ( t + x ) d x = {\sum }_{i}^{N} {i}_{j} ( t ) {\int }_{n}^{∞} \vert x - Δ {t}_{peak} \vert {e}^{- x / {τ}_{j}} d x \qquad ( 33 )$$

If, for example, u=x−Δtₚₑₐₖ, dv=e^{-x/τ}^{ⱼ}dx, then du=dx, v=−τⱼe^{-x/τ}^{ᵢ}. Integrating by parts yields

∫udv=∫(x−Δtₚₑₐₖ)e^{x/τ}^{ⱼ}dx=uv−∫vdu=−τⱼ(x−Δtₚₑₐₖ+τⱼ)e^{x/τ}^{ⱼ} (34)

Thus,

$${\sum }_{j}^{N} {i}_{j} ( t ) {\int }_{0}^{∞} \vert x - Δ {t}_{peak} \vert {e}^{- \frac{x}{{τ}_{j}}} d x = {\sum }_{j}^{N} {i}_{j} ( t ) {τ}_{j} [ {[ ( x - Δ {t}_{peak} + {τ}_{j} ) {e}^{- \frac{x}{{τ}_{j}}} ]}_{0}^{Δ {t}_{peak}} - {[ ( x - Δ {t}_{peak} + {τ}_{j} ) {e}^{- \frac{x}{{τ}_{j}}} ]}_{Δ {t}_{peak}}^{∞} ] = - {\sum }_{j}^{N} {i}_{j} ( t ) {τ}_{j} ( Δ {t}_{peak} - {τ}_{j} ) \qquad ( 35 )$$

In another aspect, the breadth or shape may be characterized by the integral of the postsynaptic potential value weighted by the square of the time difference from the peak, which may be given by

$${\int }_{0}^{∞} {( x - Δ {t}_{peak} )}^{2} i ( t + x ) d x {\sum }_{j}^{N} {i}_{j} ( t ) {\int }_{0}^{∞} {( x - Δ {t}_{peak} )}^{2} {e}^{- x / {τ}_{j}} d x \qquad ( 36 )$$

Using integration by parts twice yields

$${\sum }_{i}^{N} {i}_{j} ( t ) {\int }_{0}^{∞} {( x - Δ {t}_{peak} )}^{2} {e}^{- x / {τ}_{j}} d x = - {\sum }_{j}^{N} {i}_{j} ( t ) {τ}_{j} {e}^{- x / {τ}_{j}} [ {( x - Δ {t}_{peak} )}^{2} + 2 ( x - Δ {t}_{peak} ) {τ}_{j} + 2 {τ}_{j}^{2} ] \qquad ( 37 )$$

In yet another aspect, the breadth or shape may be characterized by a time difference from the peak time to a point at which the postsynaptic potential falls by a predetermined amount (e.g., by 3 dB).

Alternative measures or units to characterize the breadth (e.g., time units or other units) may also be used.

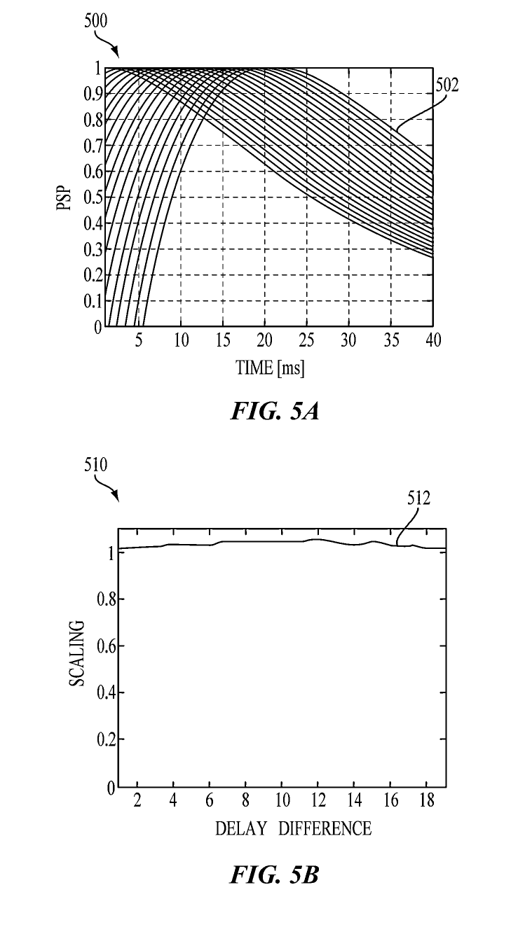

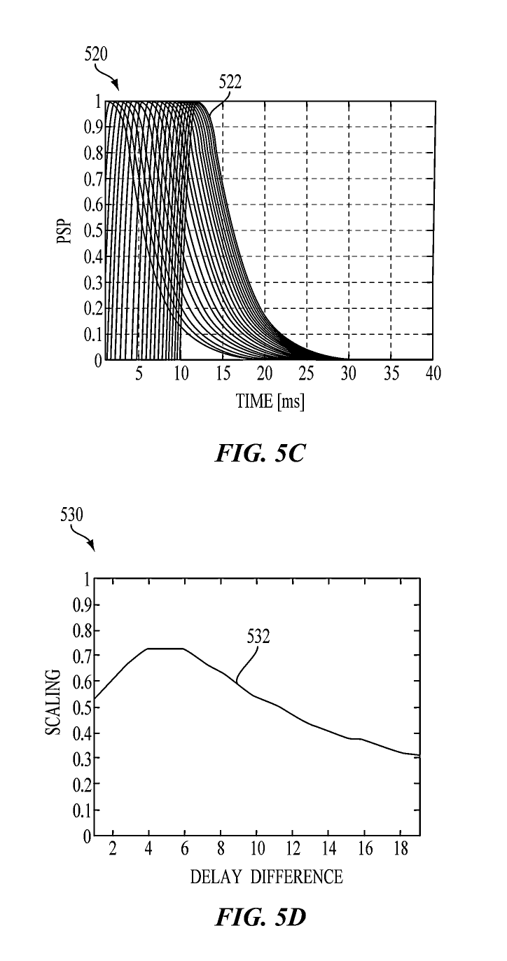

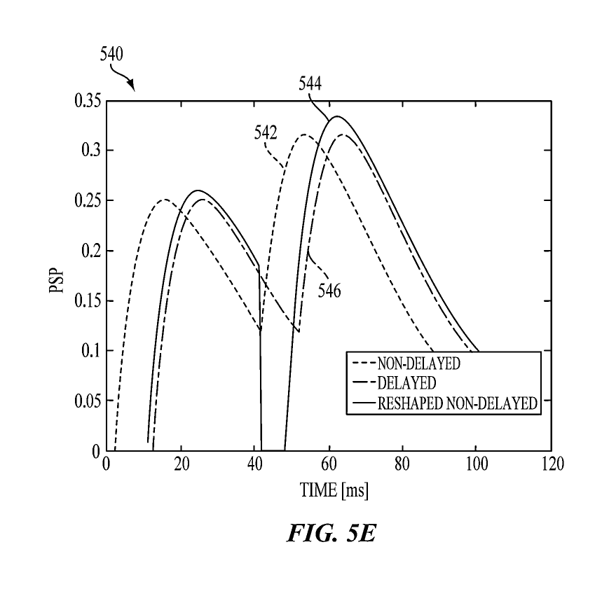

FIG. 5A shows a graph 500 illustrating an example of a shifted postsynaptic potential in accordance with aspects of the present disclosure. Referring to FIG. 5A, a postsynaptic potential may be shaped with two exponential components having zero relative time offsets, initial amplitudes iⱼ(t₀)=<−0.5,1>, and time constants τⱼ=<10.20>. A difference in arrival time (delay difference) can be achieved by shifting this postsynaptic potential or by using one reshaping exponential component with time constant τ_{c}ⁱ=14 by determining the initial amplitude of the reshaping component as i_{q}′(t₀)≅αΔt, where α≅0.035. With a desired delay of 1 ms, reshaping components may be determined. Accordingly, reshaped postsynaptic potentials 502 are generated in steps according to the desired delay of 1 ms.

FIG. 5B is a graph 510, which shows a relationship between the scalar input values and the delay difference 512 for the exemplary configuration of FIG. 5A. As shown in FIG. 5B, the relationship between the scalar input values and the delay difference 512 is nearly linear. This may be due, at least in part, to the choice of τ_{q}ⁱ, which permits the approximation of α(t)=α. Of course, this is merely exemplary, and in some cases, the selection of parameters or range of delay may degrade the linearity of the relationship between scalar input values and delay difference. Accordingly, the scalar input values may be given by:

i_{q}′(t₀)=αΔt′, (38)

where Δt′ is a remapping of Δt (or even Δt′=Δt).

For example, FIG. 5C illustrates a postsynaptic potential shaped with two exponential components having zero relative time offsets, initial amplitudes iⱼ(t₀)=<−1, 1>, and time constants τⱼ=<1,3>. A difference in arrival time (delay difference) can be achieved by shifting this postsynaptic potential or by using one reshaping exponential component with time constant τ_{q}′=2 by determining the initial amplitude of the reshaping component as (t_{q}′(t₀)≅αΔt, where α≅0.25. In FIG. 5D, the relationship between the scalar input values and the delay difference is shown via curve 532. As shown, the relationship is less linear than the relationship shown via curve 512 in FIG. 5B with respect to FIG. 5A. This may be resolved by either computing α(t), i.e. as a function of the delay, or by remapping the time using a remapping function, i.e. Δt′=f(Δt) where f_{O} is the inverse of the curve 532 shown in FIG. 5D.

In any event, the amount of input to inject at a different delay (even zero delay) via the reshaping component as a linear function of the amount of change to the delay or remapped amount of change to the delay may be readily determined.

$${i}^{′} ( t ) = {\sum }_{j}^{N} {i}_{j} ( {t}_{0} ) {e}^{- ( {t}_{f} - {t}_{o} ) / {τ}_{j}} + {\sum }_{q}^{M} {i}_{q}^{′} ( {t}_{0} ) {e}^{- ( {t}_{f} - {t}_{o} ) / {τ}_{q}^{′}} \qquad ( 39 )$$

Accordingly, the techniques of the present disclosure provide the flexibility to use whatever delay (even zero delay) is desired.

In some aspects, multiple inputs having different delays may also be approximated. FIG. 5E shows a graph 540 that illustrates an approximated postsynaptic potential including multiple inputs having different delays. In this exemplary configuration, shaping parameters iⱼ(t₀)=<−1, 1>, and time constants τⱼ=<10,20> and reshaping parameters τ_{q}′=15 and α≅0.04 are for the model i_{q}′(t₀)≅αΔt. In addition, there are two inputs with a time difference of arrival of 40 ms. There is also a synaptic delay of 10 ms. Thus, the un-delayed postsynaptic potential (542) is delayed by the time it arrives at the postsynaptic soma (546). However, instead of delaying the postsynaptic potential (i.e., time shifting) to obtain the delayed postsynaptic potential, in accordance with aspects of the present disclosure, the non-delayed postsynaptic potential may be reshaped with the reshaping components (544).

In this example, one difference between the delayed postsynaptic potential and the reshaped non-delayed postsynaptic potential is the lack of input around 45 ms. This is caused by the application of the second input at around 41 ms. The actual delayed postsynaptic potential for the second input would start at 51 ms. However, because the actual delayed postsynaptic potential is not used, the non-delayed postsynaptic potential may be reshaped at the non-delayed start time. This includes the reshaping component, which is a negative initial quantity. Because the reshaping component is shared between multiple inputs in this example, the reshaped postsynaptic potential generated by the first input may be affected. Generally, this may occur when non-delayed input times are offset by an amount within a predetermined range. Stated differently, sharing components may work well if inputs have start times that are relatively close or that are relatively far apart.

A countermeasure to the above situation is to use separate components. In the worst case, enough separate component sets are used to distinguish different relative delays. In other words, a separate component is not used for two inputs that have the same delayed peak (or which have delayed peaks close in time).

In some configurations, separate components may be used for shaping, reshaping, or both. In some configurations, a pool of components may be used when applying postsynaptic potentials for shaping, reshaping, or both. Further, each component in the pool may be overloaded to handle multiple postsynaptic potentials. In some configurations, a strategy may be used to allocate inputs to components. For example, inputs that would have similar (closed) delayed peaks may share a component. Otherwise, a component already handling one input may be chosen to handle a second input such that the component to be chosen has the greatest time difference (existing input peak to second input peak).

In some configurations, the reshaping and/or shaping component initial values may be rescaled so that the peak value is approximately the same as it would be if the actual delayed postsynaptic potential were produced. This may occur in a variety of ways, such as by solving for the peak time and scaling or by using a lookup table.

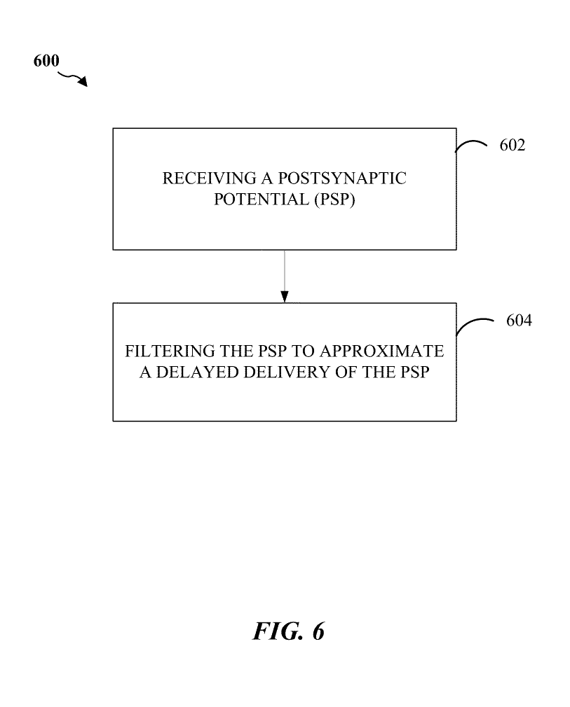

FIG. 6 illustrates a method 600 for approximating a delay for a postsynaptic potential. In block 602, a neuron model receives a postsynaptic potential. Furthermore, in block 604, the neuron model filters the postsynaptic potential to approximate a delayed delivery of the postsynaptic potential. In some aspects, the filter has multiple state values (e.g., scalar input values, exponential components or other state values). Each of the state values may correspond to or represent a different delay. In some aspects, the state values may be cascades filters. In some aspects, the method may also include controlling an impulse response to reshape the postsynaptic potential.

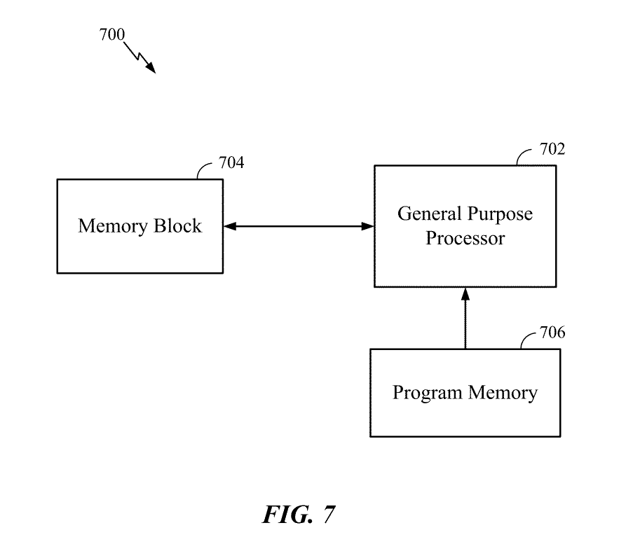

FIG. 7 illustrates an example implementation 700 of the aforementioned approximating a delayed delivery of a postsynaptic potential using a general-purpose processor 702 in accordance with certain aspects of the present disclosure. Variables (neural signals), synaptic weights, system parameters associated with a computational network (neural network), delays, frequency bin information, scalar input values and state values associated with the postsynaptic potential may be stored in a memory block 704, while instructions executed at the general-purpose processor 702 may be loaded from a program memory 706. In an aspect of the present disclosure, the instructions loaded into the general-purpose processor 702 may comprise code for receiving a postsynaptic potential and/or filtering the postsynaptic potential to approximate a delayed delivery of the postsynaptic potential.

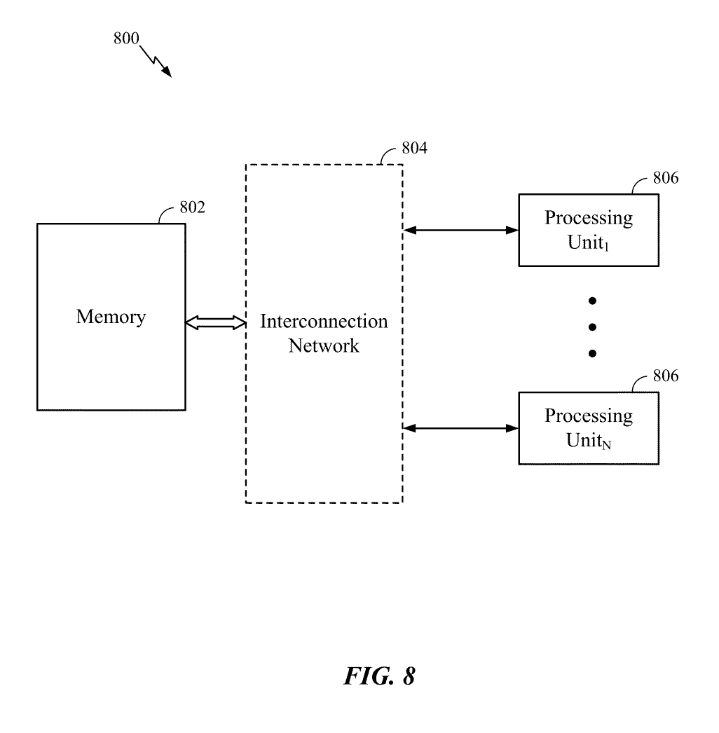

FIG. 8 illustrates an example implementation 800 of the aforementioned approximating a delayed delivery of a postsynaptic potential where a memory 802 can be interfaced via an interconnection network 804 with individual (distributed) processing units (neural processors) 806 of a computational network (neural network) in accordance with certain aspects of the present disclosure. Variables (neural signals), synaptic weights, system parameters associated with the computational network (neural network) delays, frequency bin information, scalar input values and/or state values associated with the postsynaptic potential may be stored in the memory 802, and may be loaded from the memory 802 via connection(s) of the interconnection network 804 into each processing unit (neural processor) 806. In an aspect of the present disclosure, the processing unit 806 may be configured to receive a postsynaptic potential and/or filter the postsynaptic potential to approximate a delayed delivery of the postsynaptic potential.

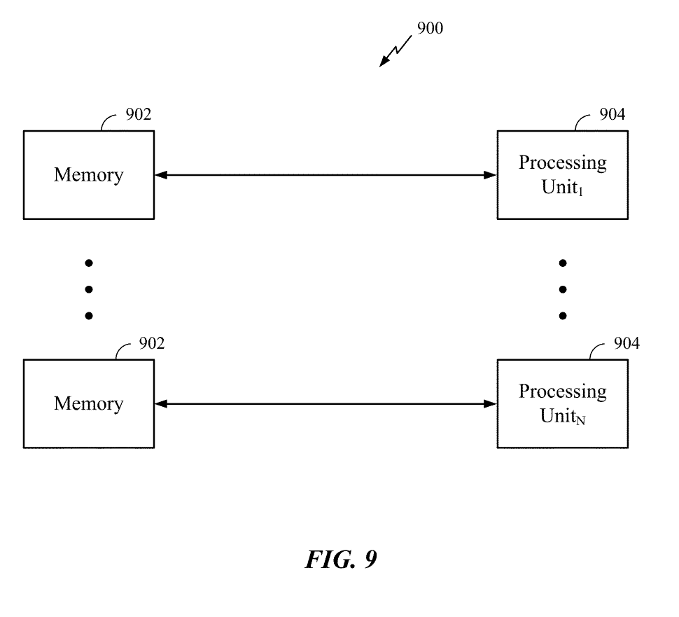

FIG. 9 illustrates an example implementation 900 of the aforementioned approximating a delayed delivery of a postsynaptic potential. As illustrated in FIG. 9, one memory bank 902 may be directly interfaced with one processing unit 904 of a computational network (neural network). Each memory bank 902 may store variables (neural signals), synaptic weights, and/or system parameters associated with a corresponding processing unit (neural processor) 904, delays, frequency bin information, and scalar input values and state values associated with the postsynaptic potential. In an aspect of the present disclosure, the processing unit 904 may be configured to receive a postsynaptic potential and/or filter the postsynaptic potential to approximate a delayed delivery of the postsynaptic potential.

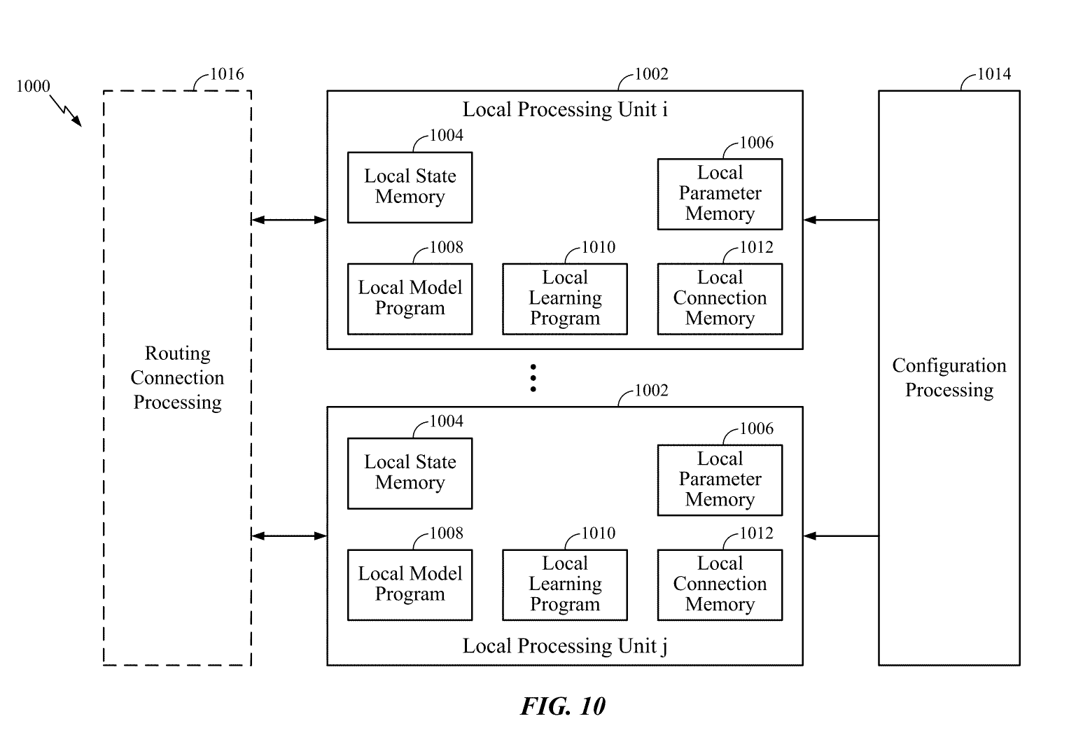

FIG. 10 illustrates an example implementation of a neural network 1000 in accordance with certain aspects of the present disclosure. As illustrated in FIG. 10, the neural network 1000 may have multiple local processing units 1002 that may perform various operations of methods described above. Each local processing unit 1002 may comprise a local state memory 1004 and a local parameter memory 1006 that store parameters of the neural network. In addition, the local processing unit 1002 may have a memory 1008 with local (neuron) model program, a memory 1010 with local learning program, and a local connection memory 1012. Furthermore, as illustrated in FIG. 10, each local processing unit 1002 may be interfaced with a unit 1014 for configuration processing that may provide configuration for local memories of the local processing unit, and with routing connection processing elements 1016 that provide routing between the local processing units 1002.

According to certain aspects of the present disclosure, each local processing unit 1002 may be configured to determine parameters of the neural network based upon desired one or more functional features of the neural network, and develop the one or more functional features towards the desired functional features as the determined parameters are further adapted, tuned and updated.

In one configuration, a neural network, such as the neural network of the aspects of the present disclosure, is configured to approximate a delayed delivery of a postsynaptic potential. The neural network may include means for receiving a postsynaptic potential and a means for filtering the postsynaptic potential. In one aspect, the receiving means and/or filtering means may be the program memory 706, memory block 1004, memory 802, interconnection network 804, processing units 806, processing unit 904, local processing units 1002, and or the routing connection processing elements 1016 configured to perform the functions recited by the receiving and/or filtering means.

In another configuration, the aforementioned means may be any module or any apparatus configured to perform the functions recited by the aforementioned means. That is, the various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the FIG. 10, those operations may have corresponding counterpart means-plus-function components with similar numbering.

As used herein, the term “determining” encompasses a wide variety of actions. For example, “determining” may include calculating, computing, processing, deriving, investigating, looking up (e.g., looking up in a table, a database or another data structure), ascertaining and the like. In addition, “determining” may include receiving (e.g., receiving information), accessing (e.g., accessing data in a memory) and the like. Further, “determining” may include resolving, selecting, choosing, establishing and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general-purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described herein. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method of approximating delay for postsynaptic potentials, the method comprising:
receiving a postsynaptic potential (PSP); and
filtering the postsynaptic potential to approximate a delayed delivery of the postsynaptic potential.

2. The method of claim 1, in which the filtering comprises a plurality of state values to represent different delays.

3. The method of claim 2, further comprising:
receiving a delay value assigned to the postsynaptic potential; and
contributing to the state values based at least in part on the delay value.

4. The method of claim 3, in which the contributing is based at least in part on a contributed value selected to retain a same area under the postsynaptic potential.

5. The method of claim 3, in which the contributing is based at least in part on retaining a specific peak value of the postsynaptic potential.

6. The method of claim 2, further comprising controlling an impulse response to shape the postsynaptic potential.

7. The method of claim 2 in which the plurality of state values comprise cascaded filters.

8. An apparatus for approximating delay for postsynaptic potentials, comprising:
a memory;
at least one processor coupled to the memory, the at least one processor being configured:
to receive a postsynaptic potential (PSP); and
to filter the postsynaptic potential to approximate a delayed delivery of the postsynaptic potential.

9. The apparatus of claim 8, in which the at least one processor is configured with a plurality of state values to represent different delays.

10. The apparatus of claim 9, in which the at least one processor is further configured:
to receive a delay value assigned to the postsynaptic potential; and
to contribute to the state values of a filter based at least in part on the delay value.

11. The apparatus of claim 10, in which the at least one processor is further configured to contribute to the state values based at least in part on a contributed value selected to retain a same area under the postsynaptic potential.

12. The apparatus of claim 10, in which the at least one processor is further configured to contribute to the state values based at least in part on retaining a specific peak value of the postsynaptic potential.

13. The apparatus of claim 9, in which the at least one processor is further configured to control an impulse response to shape the postsynaptic potential.

14. The apparatus of claim 9 in which the plurality of state values comprise cascaded filters.

15. An apparatus for approximating delay for postsynaptic potentials, comprising:
means for receiving a postsynaptic potential; and
means for filtering the postsynaptic potential to approximate a delayed delivery of the postsynaptic potential.

16. The apparatus of claim 15, in which the filtering means comprises a plurality of state values to represent different delays.

17. The apparatus of claim 16, further comprising:
means for receiving a delay value assigned to the postsynaptic potential; and
means for contributing to the state values based at least in part on the delay value.

18. The apparatus of claim 17, in which the contributing means is configured to contribute to the state values based at least in part on a contributed value selected to retain a same area under the postsynaptic potential.

19. The apparatus of claim 17, in which the contributing means is configured to contribute to the state values based at least in part on retaining a specific peak value of the postsynaptic potential.

20. The apparatus of claim 16, further comprising means for controlling an impulse response to shape the postsynaptic potential.

21. The apparatus of claim 16 in which the plurality of state values comprise cascaded filters.

22. A computer program product for approximating delay for postsynaptic potentials, comprising:
a non-transitory computer readable medium having encoded thereon program code, the program code comprising:
program code to receive a postsynaptic potential; and
program code to filter the postsynaptic potential to approximate a delayed delivery of the postsynaptic potential.

23. The computer program product of claim 22, in which the program code comprises a plurality of state values representing different delays.

24. The computer program product of claim 23, in which the program code further comprises:
program code to receive a delay value assigned to the postsynaptic potential; and
program code to contribute to the state values of a filter based at least in part on the delay value.

25. The computer program product of claim 24, in which the program code further comprises program code to contribute to the state values based at least in part on a contributed value selected to retain a same area under the postsynaptic potential.

26. The computer program product of claim 24, in which the program code further comprises program code to contribute to the state values based at least in part on retaining a specific peak value of the postsynaptic potential.

27. The computer program product of claim 23, in which the program code further comprises program code to control an impulse response to shape the postsynaptic potential.

28. The computer program product of claim 23, in which the plurality of state values comprise cascaded filters.
